(19) United States
(12) Patent Application Publication
(10) Pub. No.: US 2022/0095217 A1
(43) Pub. Date: Mar. 24, 2022

(54) APPARATUS AND METHOD OF PROVIDING VOICE CALL SERVICE

(71) Applicant: GUANGDONG OPPO MOBILE TELECOMMUNICATIONS CORP., LTD., Dongguan (CN)

(72) Inventor: Yongsheng SHI, Palo Alto, CA (US)

(73) Assignee: GUANGDONG OPPO MOBILE TELECOMMUNICATIONS CORP., LTD., Dongguan (CN)

(21) Appl. No.: 17/523,327

(22) Filed: Nov. 10, 2021

Related U.S. Application Data
(63) Continuation of application No. PCT/CN2020/103496, filed on Jul. 22, 2020.
(60) Provisional application No. 62/878,241, filed on Jul. 24, 2019.

(51) Int. Cl. H04W 48/20; H04W 76/18; H04W 40/12; H04W 36/30; H04L 5/00

(52) U.S. Cl. CPC H04W 48/20; H04W 76/18; H04L 65/1016; H04W 36/30; H04L 5/006; H04W 40/12

(57) ABSTRACT

An apparatus and a method of providing a voice call service are provided. The method includes maintaining cell lists of unreliable voice over long term evolution (VoLTE) cells, wherein the cell lists include a first cell list and a second cell list; and when receiving an unreliable VoLTE service from a modem, adding a cell to the first cell list. This can improve voice quality and reliability in a poor LTE coverage.

### CROSS REFERENCE TO RELATED APPLICATIONS

This application is a continuation of International Application No. PCT/CN2020/103496, filed on Jul. 22, 2020, which claims priority of a U.S. provisional patent application Ser. No. 62/878,241 filed on Jul. 24, 2019, both of which are hereby incorporated by reference.

### FIELD OF DISCLOSURE

The present disclosure relates to the field of communication systems, and more particularly, to an apparatus and a method of providing a voice call service, which can provide a good communication performance and high reliability.

### BACKGROUND

A user equipment may enter a poor long term evolution (LTE) coverage where a reference signal receiving power (RSRP) of a serving cell is good, but a signal-to-noise ratio (SNR) of the serving cell is bad. According a third generation partnership project (3GPP) specification, the user equipment cannot trigger an inter-radio access technology (IRAT) measurement report to assist a network to handover the user equipment to a global system for mobile communication (GSM) cell. Therefore, an ongoing voice over long term evolution (VoLTE) call maybe impacted or get dropped.

Issues in field are as follows:

1. VoLTE call poor quality (packet drop) due to low SNR (poor network deployment, same frequency cell interference). 2. A network configures GSM event B2, but a trigger condition is based on RSRP. Because RSRP of an LTE serving cell is good, the GSM event B2 is not triggered. Therefore, the network cannot handover the user equipment to a GSM for a single radio voice call continuity (SRVCC). 3. Call is dropped later due to a radio link failure (RLF).

Both the user equipment and the network follow the 3GPP specification. However, VoLTE call is still dropped in the above-mentioned scenario. Therefore, there is no viable solution to handle the issues.

Therefore, there is a need for an apparatus and a method of providing a voice call service, which can solve issues in the prior art and improve voice quality and reliability in a poor LTE coverage.

### SUMMARY

An object of the present disclosure is to propose an apparatus and a method of providing a voice call service, which can solve issues in the prior art and improve voice quality and reliability in a poor LTE coverage.

In a first aspect of the present disclosure, a method of providing a voice call service of a user equipment comprises maintaining cell lists of unreliable voice over long term evolution (VoLTE) cells, wherein the cell lists comprise a first cell list and a second cell list; and when receiving an unreliable VoLTE service from a modem, adding a cell to the first cell list.

In a second aspect of the present disclosure, a method of providing a voice call service of a user equipment comprises performing a first action, a second action, or a third action, wherein: the first action comprises enabling global system for mobile communication (GSM) measurement events B1/B2, if the GSM measurement events B1/B2 are not configured; the second action comprises performing the first action and accelerating a single radio voice call continuity (SRVCC) to a GSM; the third action comprises sending a tracking area update (TAU) to a network to change voice domain preference of evolved universal mobile telecommunications system (UMTS) terrestrial radio access network (E-UTRAN) to circuit switched (CS) voice only.

In a third aspect of the present disclosure, a user equipment comprises a memory, a transceiver, and a processor coupled to the memory and the transceiver. The processor is configured to maintain cell lists of unreliable voice over long term evolution (VoLTE) cells, wherein the cell lists comprise a first cell list and a second cell list; and when the transceiver receives an unreliable VoLTE service from a modem, the processor adds a cell to the first cell list.

In a fourth aspect of the present disclosure, a user equipment comprises a memory, a transceiver, and a processor coupled to the memory and the transceiver. The processor is configured to perform a first action, a second action, or a third action, wherein: the first action comprises enabling global system for mobile communication (GSM) measurement events B1/B2, if the GSM measurement events B1/B2 are not configured; the second action comprises performing the first action and accelerating a single radio voice call continuity (SRVCC) to a GSM; the third action comprises sending a tracking area update (TAU) to a network to change voice domain preference of evolved universal mobile telecommunications system (UMTS) terrestrial radio access network (E-UTRAN) to circuit switched (CS) voice only.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a user equipments (UE) and a base station (BS) (e.g., gNB) of communication in a communication network system according to an embodiment of the present disclosure.

FIG. 2 is a flowchart illustrating a method of providing a voice call service of a UE according to an embodiment of the present disclosure.

FIG. 3 is a flowchart illustrating a method of providing a voice call service of a UE according to another embodiment of the present disclosure.

FIG. 4 is a schematic diagram illustrating a cell state transition according to an embodiment of the present disclosure.

FIG. 5 is a table illustrating a UE applying an action based on a cell list and a UE state according to an embodiment of the present disclosure.

FIG. 6 is a schematic diagram illustrating a state machine of voice over long term evolution (VoLTE) status according to an embodiment of the present disclosure.

FIG. 7 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

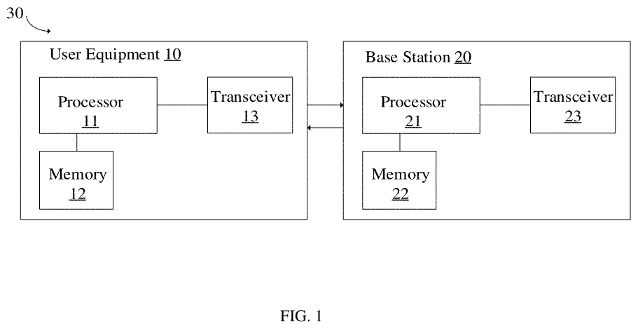

FIG. 1 illustrates that, in some embodiments, a user equipment (UE) 10 and a base station (BS) (e.g., gNB) 20 of communication in a communication network system 30 according to an embodiment of the present disclosure are provided. The communication network system 30 includes one or more UEs 10 of a cell and the BS 20. The UE 10 may include a memory 12, a transceiver 13, and a processor 11 coupled to the memory 12, the transceiver 13. The base station 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of first information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the processor 11 is configured to maintain cell lists of unreliable voice over long term evolution (VoLTE) cells, wherein the cell lists comprise a first cell list and a second cell list; and when the transceiver 13 receives an unreliable VoLTE service from a modem, the processor 11 adds a cell to the first cell list. can solve issues in the prior art and improve voice quality and reliability in a poor LTE coverage. In an example, the processor comprises an application processor (AP). The AP is configured to maintain cell lists of unreliable VoLTE cells.

In some embodiments, the processor 11 is configured to perform a first action, a second action, or a third action, wherein: the first action comprises enabling global system for mobile communication (GSM) measurement events B1/B2, if the GSM measurement events B1/B2 are not configured; the second action comprises performing the first action and accelerating a single radio voice call continuity (SRVCC) to a GSM; the third action comprises sending a tracking area update (TAU) to a network to change voice domain preference of evolved universal mobile telecommunications system (UMTS) terrestrial radio access network (E-UTRAN) to circuit switched (CS) voice only. This can solve issues in the prior art and improve voice quality and reliability in a poor LTE coverage. The proposed solution also tries to keep the UE in LTE as long as possible. The 3 different actions (such as the first action, the second action, and third action) are defined to handle different levels of severity.

In some embodiments, the first cell list comprises a limited VoLTE cell list, and the second cell list comprises a forbidden VoLTE cell list. In an example, the limited VoLTE cell list is a Cell_List_{VoLTE_Limited} as List A and the forbidden VoLTE cell list is a Cell_List_{VoLTE_Forbidden} as List B.

In some embodiments, when the transceiver 13 receives a number of unreliable VoLTE service greater than or equal to N on the same cell, the processor 11 moves the cell from the first cell list to the second cell list; or otherwise the processor 11 keeps the cell in the first cell list, where N is an integer. In some embodiments, each cell is associated with a timer (such as T_volte_unreliable). In some embodiments, when the timer expires, the processor 11 removes the cell from the first cell list or the second cell list. In some embodiments, the cell in the first cell list or the second cell list comprises at least one of following cell information: information to identify the cell; a time stamp; or a number of unreliable VoLTE service. In some embodiments, the information to identify the cell comprises at least one of following information: public land mobile network (PLMN) information; band information; frequency information; physical cell identity (PCI) information; or location information. In some embodiments, the information to identify the cell is via a generic positioning protocol (GPP) or wireless fidelity (WiFi).

In some embodiments, the processor 11 is configured to request the modem to report the information to identify the cell. In some embodiments, the time stamp is associated with a time stamp when the cell is added in the first cell list, and the processor 11 is configured to decide how long the cell is kept in the first cell list by the timer.

In some embodiments, in the first action, the processor 11 manipulates LTE A2 events to report a quality of an LTE serving cell below a threshold. This allows a network (such as the base station 20) to configure IRAT measurement events (GSM measurement events B1/B2).

In some embodiments, in the second action, the processor 11 starts a GSM/enhanced data rates for GSM evolution (EDGE) radio access network (GERAN) measurement and reports satisfied GERAN cells to the network to trigger the SRVCC, regardless a reference signal receiving power (RSRP) of an LTE serving cell.

In some embodiments, in the third action, the transceiver 13 sends TAU to the network to change voice domain preference of E-UTRAN to CS voice only. This is to disable VoLTE.

In some embodiments, a state of the user equipment 10 comprises an LTE idle camped state; an LTE connected state; an LTE VoLTE call connected state; or an LTE VoLTE call connected state having unreliable VoLTE service. In some embodiments, when the user equipment 10 is in the LTE idle camped state and the cell is not in the first cell list or the second cell list, the processor 11 performs no action. In some embodiments, when the user equipment 10 is in the LTE idle camped state and the cell is in the first cell list, the processor 11 performs no action. In some embodiments, when the user equipment 10 is in the LTE idle camped state and the cell is in the second cell list, the processor 11 performs the third action. In some embodiments, when the user equipment 10 is in the LTE connected state and the cell is not in the first cell list or the second cell list, the processor 11 performs no action. In some embodiments, when the user equipment 10 is in the LTE connected state and the cell is in the first cell list, the processor 11 performs the first action. In some embodiments, when the user equipment 10 is in the LTE connected state and the cell is in the second cell list, the processor 11 performs the first action.

In some embodiments, when the user equipment 10 is in the LTE VoLTE call connected state and the cell is not in the first cell list or the second cell list, the processor 11 performs no action. In some embodiments, when the user equipment 10 is in the LTE VoLTE call connected state and the cell is not in the first cell list, the processor 11 performs the second action. In some embodiments, when the user equipment 10 is in the LTE VoLTE call connected state and the cell is in the second cell list, the processor 11 performs the second action. In some embodiments, when the user equipment 10 is in the LTE VoLTE call connected state having unreliable VoLTE service and the cell is not in the first cell list or the second cell list, the cell is added to the first cell list and the processor 11 performs the second action. In some embodiments, when the user equipment 10 is in the LTE VoLTE call connected state having unreliable VoLTE service and the cell is in the first cell list, the cell is added to the second cell list if a condition is met.

In some embodiments, whenever the third action is applied, the processor 11 follows at least one of followings: starting a hysteresis timer (such as T_volte_off); before the hysteresis timer expires, the processor does not enable VoLTE even if the user equipment is camped on a cell not in the second cell list; or disabling VoLTE when the user equipment is in a cell in the second cell list. In details, this is a one-way timer. The UE should disable VoLTE as soon as the UE is in any cell in the second list.

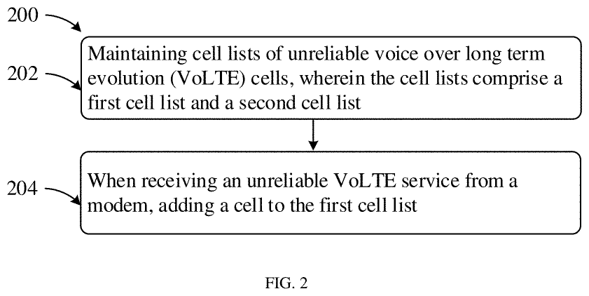

FIG. 2 illustrates a method 200 of providing a voice call service of a UE according to an embodiment of the present disclosure. In some embodiments, the method 200 includes: a block 202, maintaining cell lists of unreliable voice over long term evolution (VoLTE) cells, wherein the cell lists comprise a first cell list and a second cell list, and a block 204, when receiving an unreliable VoLTE service from a modem, adding a cell to the first cell list. This can solve issues in the prior art and improve voice quality and reliability in a poor LTE coverage.

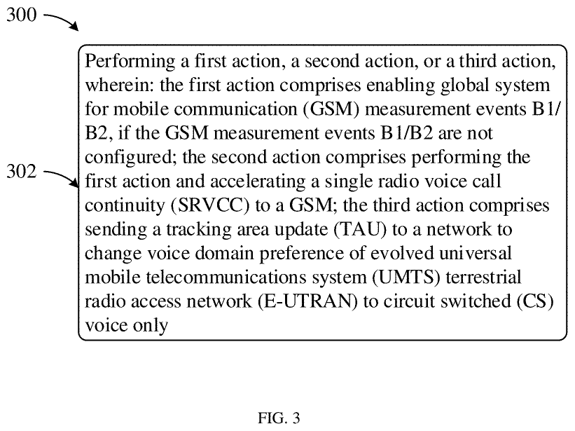

FIG. 3 illustrates a method 300 of providing a voice call service of a UE according to another embodiment of the present disclosure. In some embodiments, the method 300 includes: a block 302, performing a first action, a second action, or a third action, wherein: the first action comprises enabling global system for mobile communication (GSM) measurement events B1/B2, if the GSM measurement events B1/B2 are not configured; the second action comprises performing the first action and accelerating a single radio voice call continuity (SRVCC) to a GSM; the third action comprises sending a tracking area update (TAU) to a network to change voice domain preference of evolved universal mobile telecommunications system (UMTS) terrestrial radio access network (E-UTRAN) to circuit switched (CS) voice only. This can solve issues in the prior art and improve voice quality and reliability in a poor LTE coverage. The proposed solution also tries to keep the UE in LTE as long as possible. The 3 different actions (such as the first action, the second action, and third action) are defined to handle different levels of severity.

In some embodiments, the first cell list comprises a limited VoLTE cell list, and the second cell list comprises a forbidden VoLTE cell list. In an example, the limited VoLTE cell list is a Cell_List_{VoLTE_Limited} as List A and the forbidden VoLTE cell list is a Cell_List_{VoLTE_Forbidden} as List B. In some embodiments, the method comprises when receiving a number of unreliable VoLTE service greater than or equal to N on the same cell, moving the cell from the first cell list to the second cell list; or otherwise keeping the cell in the first cell list, where N is an integer. In some embodiments, each cell is associated with a timer (such as T_volte_unreliable). In some embodiments, the method comprises when the timer expires, removing the cell from the first cell list or the second cell list.

In some embodiments, the cell in the first cell list or the second cell list comprises at least one of following cell information: information to identify the cell; a time stamp; or a number of unreliable VoLTE service. In some embodiments, the information to identify the cell comprises at least one of following information: public land mobile network (PLMN) information; band information; frequency information; physical cell identity (PCI) information; or location information. In some embodiments, the information to identify the cell is via a generic positioning protocol (GPP) or wireless fidelity (WiFi). In some embodiments, the method further comprises requesting the modem to report the information to identify the cell. In some embodiments, the time stamp is associated with a time stamp when the cell is added in the first cell list, and the method further comprises deciding how long the cell is kept in the first cell list by the timer.

In some embodiments, in the first action, the user equipment manipulates LTE A2 events to report a quality of an LTE serving cell below a threshold. This allows a network (such as the base station 20) to configure IRAT measurement events (GSM measurement events B1/B2).

In some embodiments, in the second action, the user equipment starts a GSM/enhanced data rates for GSM evolution (EDGE) radio access network (GERAN) measurement and reports satisfied GERAN cells to the network to trigger the SRVCC, regardless a reference signal receiving power (RSRP) of an LTE serving cell.

In some embodiments, in the third action, the transceiver 13 sends TAU to the network to change voice domain preference of E-UTRAN to CS voice only. This is to disable VoLTE.

In some embodiments, a state of the user equipment comprises an LTE idle camped state; an LTE connected state; an LTE VoLTE call connected state; or an LTE VoLTE call connected state having unreliable VoLTE service. In some embodiments, when the user equipment is in the LTE idle camped state and the cell is not in the first cell list or the second cell list, the user equipment performs no action. In some embodiments, when the user equipment is in the LTE idle camped state and the cell is in the first cell list, the user equipment performs no action. In some embodiments, when the user equipment is in the LTE idle camped state and the cell is in the second cell list, the user equipment performs the third action. In some embodiments, when the user equipment is in the LTE connected state and the cell is not in the first cell list or the second cell list, the user equipment performs no action. In some embodiments, when the user equipment is in the LTE connected state and the cell is in the first cell list, the user equipment performs the first action. In some embodiments, when the user equipment is in the LTE connected state and the cell is in the second cell list, the user equipment performs the first action.

In some embodiments, when the user equipment is in the LTE VoLTE call connected state and the cell is not in the first cell list or the second cell list, the user equipment performs no action. In some embodiments, when the user equipment is in the LTE VoLTE call connected state and the cell is not in the first cell list, the user equipment performs the second action. In some embodiments, when the user equipment is in the LTE VoLTE call connected state and the cell is in the second cell list, the user equipment performs the second action. In some embodiments, when the user equipment is in the LTE VoLTE call connected state having unreliable VoLTE service and the cell is not in the first cell list or the second cell list, the cell is added to the first cell list and the user equipment performs the second action. In some embodiments, when the user equipment is in the LTE VoLTE call connected state having unreliable VoLTE service and the cell is in the first cell list, the cell is added to the second cell list if a condition is met.

In some embodiments, whenever the third action is applied, the user equipment follows at least one of followings: starting a hysteresis timer (such as T_volte_off); before the hysteresis timer expires, the user equipment does not enable VoLTE even if the user equipment is camped on a cell not in the second cell list; or disabling VoLTE when the user equipment is in a cell in the second cell list. In details, this is a one-way timer. The UE should disable VoLTE as soon as the UE is in any cell in the second list.

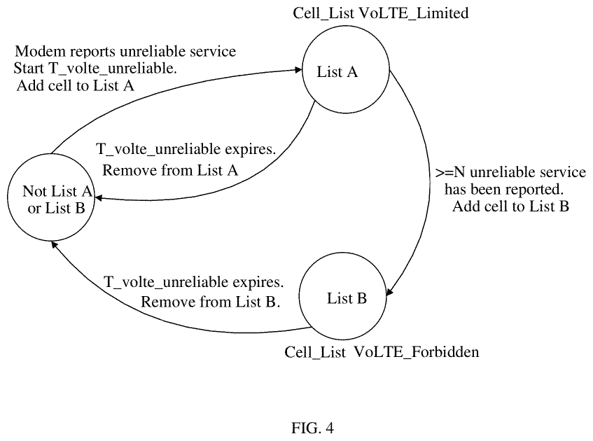

FIG. 4 illustrates a cell state transition according to an embodiment of the present disclosure. FIG. 4 illustrates that, in some embodiments, the proposed solution contains an application processor (AP) and modem side changes. The AP maintains two cell lists of unreliable VoLTE cells: Cell_List_{VoLTE_Limited} and Cell_List_{VoLTE_Forbidden}. For simplicity, in some embodiments, Cell_List_{VoLTE_Limited} is denoted as List A and Cell_List_{VoLTE_Forbidden} is denoted as List B. When the modem reports an unreliable VoLTE service, a cell is added to List A. When >=N unreliable VoLTE service is reported on the same cell, the cell is moved to List B from List A. Each cell is associated with a timer (T_volte_unreliable). When the timer expires, the cell is removed from List A or List B. The cells in List A or List B have the following cell information: 1. PLMN/Band/Frequency/PCI/Location information (via GPS/WiFi if available) to identify a cell. The modem is requested to report the above PLMN/Band/Frequency/PCI/Location information. 2. Time stamp when the cell is added. The AP can decide how long the cell is kept in the list by T_volte_unreliable. 3. Number of times unreliable VoLTE service has been reported. When the number is >=N, move the cell to List B; otherwise, keep the cell in List A.

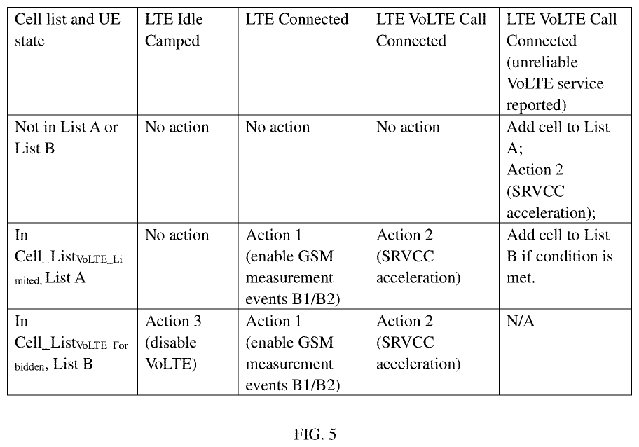

FIG. 5 is a table illustrating a UE applying an action based on a cell list and a UE state according to an embodiment of the present disclosure. FIG. 5 illustrates that, in some embodiments, the UE applies different actions according to the table illustrated in FIG. 5. In details, the proposed solution tries to keep the UE in LTE as long as possible. There are 3 different actions defined to handle different levels of severity.

Action 1: enable GSM measurement events B1/B2, if such events are not configured. To do this, the UE needs to manipulate LTE A2 events to intentionally report the quality of LTE serving cell is below a threshold. This allows the network to configure IRAT measurement events (GSM B1/B2 measurement events).

Action 2: Perform action 1; and Accelerate SRVCC to GSM. To do this, immediately start GERAN measurement and report satisfied GERAN cells to the network (to trigger SRVCC), regardless RSRP of the LTE serving cell.

Action 3: Send TAU to the network to change voice domain preference of E-UTRAN to CS Voice only. This is to disable VoLTE.

Referring to FIG. 5, in some embodiments, a state of the user equipment comprises an LTE idle camped state; an LTE connected state; an LTE VoLTE call connected state; or an LTE VoLTE call connected state having unreliable VoLTE service. In some embodiments, when the user equipment is in the LTE idle camped state and the cell is not in the first cell list or the second cell list, the user equipment performs no action. In some embodiments, when the user equipment is in the LTE idle camped state and the cell is in the first cell list, the user equipment performs no action. In some embodiments, when the user equipment is in the LTE idle camped state and the cell is in the second cell list, the user equipment performs the third action. In some embodiments, when the user equipment is in the LTE connected state and the cell is not in the first cell list or the second cell list, the user equipment performs no action. In some embodiments, when the user equipment is in the LTE connected state and the cell is in the first cell list, the user equipment performs the first action. In some embodiments, when the user equipment is in the LTE connected state and the cell is in the second cell list, the user equipment performs the first action.

Referring to FIG. 5, in some embodiments, when the user equipment is in the LTE VoLTE call connected state and the cell is not in the first cell list or the second cell list, the user equipment performs no action. In some embodiments, when the user equipment is in the LTE VoLTE call connected state and the cell is not in the first cell list, the user equipment performs the second action. In some embodiments, when the user equipment is in the LTE VoLTE call connected state and the cell is in the second cell list, the user equipment performs the second action. In some embodiments, when the user equipment is in the LTE VoLTE call connected state having unreliable VoLTE service and the cell is not in the first cell list or the second cell list, the cell is added to the first cell list and the user equipment performs the second action. In some embodiments, when the user equipment is in the LTE VoLTE call connected state having unreliable VoLTE service and the cell is in the first cell list, the cell is added to the second cell list if a condition is met.

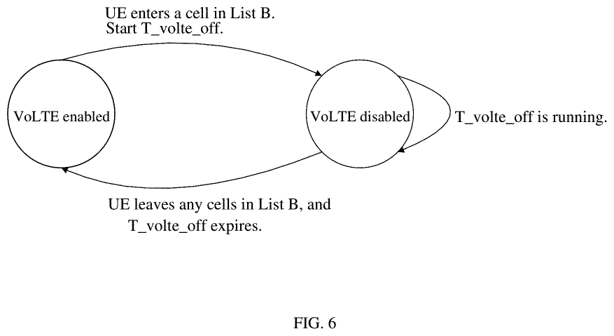

FIG. 6 illustrates a state machine of voice over long term evolution (VoLTE) status according to an embodiment of the present disclosure. FIG. 6 illustrates that, in some embodiments, to avoid Ping-Pong of frequent disabling and enabling VoLTE, whenever action 3 is applied, the UE follows: starting a hysteresis timer, T_volte_off. Before T_volte_off expires, the UE does not enable VoLTE even if the UE is camped on a cell not in List B. This is a one-way timer. The UE should disable VoLTE as soon as the UE is in any cell in List B. This thrashing activity, frequent disabling and enabling VoLTE, which is called “Ping-Pong” effect, causes unwanted performance issues. The above technical solution can avoid Ping-Pong of frequent disabling and enabling VoLTE, and therefore, performance of VoLTE is improved.

Commercial interests for some embodiments are as follows. 1. solving issues in the prior art. 2. improving voice quality and reliability in a poor LTE coverage. 3. providing a good communication performance. 4. providing a high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure propose technical mechanisms.

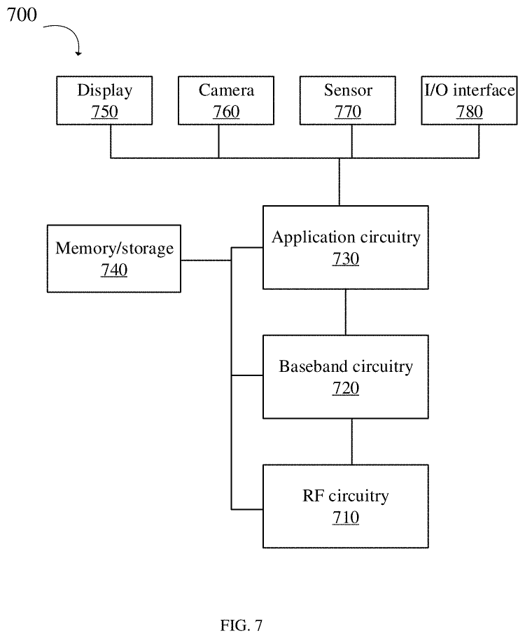

FIG. 7 is a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental states and/or location first information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the state of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of providing a voice call service of a user equipment, comprising:
maintaining cell lists of unreliable voice over long term evolution (VoLTE) cells, wherein the cell lists comprise a first cell list and a second cell list; and
when receiving an unreliable VoLTE service from a modem, adding a cell to the first cell list.

2. The method of claim 1, comprising when receiving a number of unreliable VoLTE service greater than or equal to N on the same cell, moving the cell from the first cell list to the second cell list; or otherwise keeping the cell in the first cell list, where N is an integer.

3. The method of claim 1, wherein each cell is associated with a timer.

4. The method of claim 3, comprising when the timer expires, removing the cell from the first cell list or the second cell list.

5. The method of claim 1, further comprising performing a first action, a second action, or a third action, wherein:
the first action comprises enabling global system for mobile communication (GSM) measurement events B1/B2, if the GSM measurement events B1/B2 are not configured;
the second action comprises performing the first action and accelerating a single radio voice call continuity (SRVCC) to a GSM;
the third action comprises sending a tracking area update (TAU) to a network to change voice domain preference of evolved universal mobile telecommunications system (UMTS) terrestrial radio access network (E-UTRAN) to circuit switched (CS) voice only.

6. The method of claim 5, wherein in the first action, the user equipment manipulates LTE A2 events to report a quality of an LTE serving cell below a threshold.

7. The method of claim 5, wherein in the second action, the user equipment starts a GSM/enhanced data rates for GSM evolution (EDGE) radio access network (GERAN) measurement and reports satisfied GERAN cells to the network to trigger the SRVCC, regardless a reference signal receiving power (RSRP) of an LTE serving cell.

8. The method of claim 5, wherein a state of the user equipment comprises an LTE idle camped state; an LTE connected state; an LTE VoLTE call connected state; or an LTE VoLTE call connected state having unreliable VoLTE service.

9. The method of claim 5, wherein whenever the third action is applied, the user equipment follows at least one of followings:
starting a hysteresis timer;
before the hysteresis timer expires, the user equipment does not enable VoLTE even if the user equipment is camped on a cell not in the second cell list; or
disabling VoLTE when the user equipment is in a cell in the second cell list.

10. A method of providing a voice call service of a user equipment, comprising:
performing a first action, a second action, or a third action, wherein:
the first action comprises enabling global system for mobile communication (GSM) measurement events B1/B2, if the GSM measurement events B1/B2 are not configured;
the second action comprises performing the first action and accelerating a single radio voice call continuity (SRVCC) to a GSM;
the third action comprises sending a tracking area update (TAU) to a network to change voice domain preference of evolved universal mobile telecommunications system (UMTS) terrestrial radio access network (E-UTRAN) to circuit switched (CS) voice only.

11. The method of claim 10, wherein in the first action, the user equipment manipulates LTE A2 events to report a quality of an LTE serving cell below a threshold.

12. The method of claim 10, wherein in the second action, the user equipment starts a GSM/enhanced data rates for GSM evolution (EDGE) radio access network (GERAN) measurement and reports satisfied GERAN cells to the network to trigger the SRVCC, regardless a reference signal receiving power (RSRP) of an LTE serving cell.

13. The method of claim 10, wherein a state of the user equipment comprises an LTE idle camped state; an LTE connected state; an LTE VoLTE call connected state; or an LTE VoLTE call connected state having unreliable VoLTE service.

14. The method of claim 13, further comprising maintaining cell lists of unreliable voice over long term evolution (VoLTE) cells, wherein the cell lists comprise a first cell list and a second cell list.

15. The method of claim 10, wherein whenever the third action is applied, the user equipment follows at least one of followings:
starting a hysteresis timer;
before the hysteresis timer expires, the user equipment does not enable VoLTE even if the user equipment is camped on a cell not in the second cell list; or
disabling VoLTE when the user equipment is in a cell in the second cell list.

16. The method of claim 14, further comprising when receiving an unreliable VoLTE service from a modem, adding a cell to the first cell list.

17. The method of claim 16, comprising when receiving a number of unreliable VoLTE service greater than or equal to N on the same cell, moving the cell from the first cell list to the second cell list; or otherwise keeping the cell in the first cell list, where N is an integer.

18. The method of claim 16, wherein each cell is associated with a timer.

19. The method of claim 18, comprising when the timer expires, removing the cell from the first cell list or the second cell list.

20. A user equipment, comprising:
a memory;
a transceiver; and
a processor coupled to the memory and the transceiver;
wherein the processor is configured to maintain cell lists of unreliable voice over long term evolution (VoLTE) cells, wherein the cell lists comprise a first cell list and a second cell list; and
when the transceiver receives an unreliable VoLTE service from a modem, the processor adds a cell to the first cell list.
